(19) United States
(12) Patent Application Publication
(10) Pub. No.: US 2007/0279491 A1
(43) Pub. Date: Dec. 6, 2007

(54) Method for Installing Mixed Equipment on Street Furniture Equipment

(75) Inventor: Dorothee Riviere, Bois-Guillaume (FR)

Correspondence Address: BLANK ROME LLP, 600 NEW HAMPSHIRE AVENUE, N.W., WASHINGTON, DC, 20037, US

(73) Assignee: SOCIETE CIVILE IMMOBILIERE MAGELLAN 2, MONT-SAINT-AIGNAN (FR)

(21) Appl. No.: 11/659,982

(22) PCT Filed: Aug. 5, 2005
(86) PCT No.: PCT/FR05/02042

§ 371 Date: Jul. 23, 2007

(30) Foreign Application Priority Data
Aug. 12, 2004 (FR) 0451840
Jul. 11, 2005 (FR) 0507391

(51) Int. Cl. H04N 7/18; G01S 13/02

(52) U.S. Cl. 348/143; 342/58; 725/79; 725/81; 348/E07.085

(57) ABSTRACT

The invention relates to a method for installing mixed equipment (for example, but limited to: a video surveillance camera, and/or a wireless telecommunications terminal connection, and/or a radar) on urban equipment, in particular street illumination equipment. The invention is characterized in that the mixed equipment is not permanently powered and the electronic circuits of the mixed equipment are connected to a supply circuit having a rechargeable energy storing system and a battery charger connected to the power supply circuit of the urban equipment and the mixed equipment is provided with a wireless transmitting circuit in the form of a reverse link.

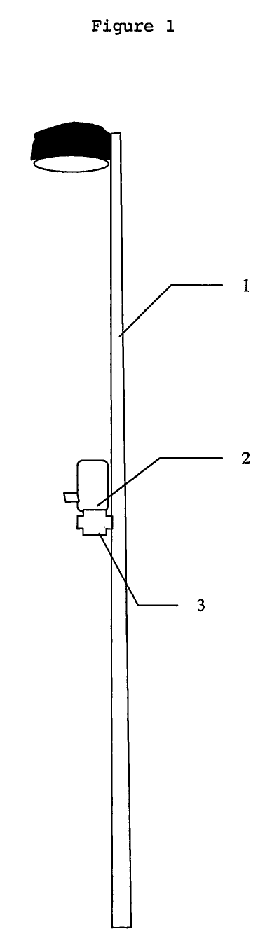

The present invention relates to the field of radars, video surveillance and wireless telecommunications and, in particular, to the domain of the installation and operation of a network of radars, video surveillance cameras and wireless telecommunication bases in an urban site.

The principle of such facilities is known, for example, from patent application PCT WO 03/73764 which describes a system and method for wireless video surveillance of a remote area using microwave frequency transmission of video data over the TCP/IP network protocol. This system comprises a remote unit equipped with one or more analogue cameras, a video encoder/decoder connected to a microwave transmitter/receiver using Ethernet transmitter/receivers connected by a twisted pair cable. The microwave transmission is received by a base unit comprising another microwave transmitter/receiver and an Ethernet transmitter/receiver connected to a computer. The base unit computer is connected to one or more computer networks in order to allow the transmission of video data to several computer terminals in the network.

The development of standards such as Wi-Fi and WiMAX has resulted in the development of such surveillance facilities or wireless telecommunication bases in urban areas. Some manufacturers market equipment such as cameras equipped with RF resources, such as the DCS-1000W or DCS-2100 products marketed by PANASONIC (registered trademark), which use the IEEE 802.11b and 802.3/3u Ethernet protocols.

Such equipment is often mounted on public lamp posts in order to benefit from the area of nocturnal illumination.

They can also be mounted on the lighting head as proposed by Japanese patents JP 2004/047388 and JP 08273410.

However, the problem posed is that of electrically connecting the mixed equipment (for example but not exclusively: video surveillance camera and/or wireless telecommunication base and/or radar). They require power supply during the day as well as during the night. For this purpose, the state of the art provides specific grid supply, independent from the urban lighting power supply, which is controlled by a programmable automaton which takes into account the time and environmental conditions for controlling the automatic switching on and off of the public lights.

The aim of the invention is to provide an improvement on such mixed equipment by avoiding the use of a specific grid supply.

To this effect, the present invention relates, in its broadest form, to a method for installing mixed equipment (for example but not exclusively: video surveillance camera and/or wireless telecommunication base and/or radar) on street furniture equipment, in particular on urban lighting equipment characterized in that said street furniture is not permanently powered, and in that the electronic circuits of said mixed equipment are connected to a supply circuit comprising a rechargeable energy storing system and a battery charger linked to the power supply circuit of said street furniture and in that said mixed equipment is equipped with a wireless transmitter circuit in the form of a reverse link.

Said mixed equipment is advantageously installed on the pole of the lighting equipment by means of a fixed support link, and a hole is made in it to allow the passage of electric cables connecting the supply circuit of said mixed equipment to the urban lighting supply circuit.

The information acquired by the mixed equipment is preferably transmitted by a radio transmission card operating in the radio frequency bands comprised between 2 and 11 GHz.

According to a particularly preferred embodiment, the information acquired by the mixed equipment is transmitted by a radio transmission card operating in the radio frequency bands comprised between 3.4 and 3.8 GHz (WiMAX).

According to a specific embodiment of the invention, a wireless telecommunication base of the mixed equipment is Wi-Fi compatible (IEEE 802.11).

According to a specific embodiment of the invention, a wireless telecommunication base of the mixed equipment is WiMAX compatible (IEEE 802.16).

According to a variation, said mixed equipment comprises a video surveillance camera.

According to another variation, said mixed equipment comprises a radar.

The present invention also relates to street furniture equipment comprising mixed equipment, which is powered by connecting to a non-permanent power supply of the street furniture, and by an energy storage system which can be recharged by a battery charger connected to said non-permanent power supply of the street furniture.

The invention will be better understood from reading the following description made in reference to a strictly non limiting example of an embodiment thereof illustrated in the single figure.

The single drawing shows a street light for urban lighting, comprising a pole 1 on which a mixed equipment casing (for example but not exclusively: video surveillance camera and/or wireless telecommunication base and/or radar) 2 is mounted by means of a support 3.

According to a first embodiment of the invention, the mixed equipment casing 2 comprises, in particular, a digital camera connected to an electronic circuit which can optionally pre-process the video signal, for example by compression or pre-analysis, the output signal of which is transmitted to a remote station by means of a radio-relay link. The transmission conforms, for example, to the 802.16 radio transmission standard, standardized by the international standardization agency IEEE and developed by the WiMAX Forum consortium.

According to another embodiment of the invention, the mixed equipment casing 2 comprises, in particular, a wireless telecommunication base such as, for example, a Wi-Fi base (IEEE 802.11), the input and output signals of which are transmitted to a remote station by means of a radio-relay reverse link such as, for example, a WiMAX link (IEEE 802.16).

According to another embodiment of the invention, the mixed equipment casing 2 comprises, in particular, a radar.

The electric and electronic circuits of the mixed equipment casing (for example but not exclusively: video surveillance camera and/or wireless telecommunication base and/or radar) 2 are powered by an energy storage system periodically recharged by a battery charger. This battery charger is connected to the non-permanent power supply of the street furniture on which the casing 2 is installed. An electronic circuit detects whether or not the main power supply is turned off and, according to the state of the main power supply, switches the power supply of the casing 2 circuits between supply from an energy storage system and charging of the energy storage systems.

1. A method of installing mixed equipment on urban equipment, comprising the steps of:
providing the mixed equipment; and
mounting the mixed equipment on the urban equipment;
wherein the urban equipment is not permanently powered, and electronic circuits of said mixed equipment are connected to a supply circuit comprising a rechargeable energy storing system and a battery charger linked to the power supply circuit of said urban equipment and in that said mixed equipment is equipped with a wireless transmitter circuit in the form of a reverse link.

2. The method of installing mixed equipment on urban equipment according to claim 1, wherein said mixed equipment is installed on a pole of the urban equipment, and wherein a hole is made in the pole to allow passage of electric cables connecting the supply circuit of said mixed equipment to the power supply circuit.

3. The method of installing mixed equipment on urban equipment according to claim 1, wherein said mixed equipment acquires information and the information acquired by the mixed equipment is transmitted by a radio transmission card operating in radio frequency bands comprised between 2 and 11 GHz.

4. The method of installing mixed equipment on urban equipment according to claim 3, wherein the information acquired by the mixed equipment is transmitted by a radio transmission card operating in radio frequency bands comprised between 3.4 and 3.8 GHz (WiMAX).

5. The method of installing mixed equipment on urban equipment according to claim 1, wherein said mixed equipment comprises a wireless telecommunication base and in that the wireless telecommunication base of the mixed equipment is WiMAX compatible (IEEE 802.16).

6. The method of installing mixed equipment on urban equipment according to claim 1, wherein said mixed equipment comprises a video surveillance camera.

7. The method of installing mixed equipment on urban equipment according to claim 1, wherein said mixed equipment comprises a radar unit.

8. Urban equipment comprising mixed equipment, which is powered by connecting to a non-permanent power supply of the urban equipment, and by an energy storage system which can be recharged by a battery charger connected to said non-permanent power supply of the urban equipment.
